(19) United States
(12) Patent Application Publication
(10) Pub. No.: US 2026/0288667 A1
(43) Pub. Date: Sep. 24, 2026

(54) ADDRESS EXPANSION CIRCUIT, COMMUNICATION INTERFACE CHIP AND BACKLIGHT SYSTEM

(71) Applicant: Silergy Semiconductor Technology (Hangzhou) LTD, Hangzhou (CN)

(72) Inventors: Yuanyu Yang, Hangzhou (CN); Shang Gao, Hangzhou (CN); Yu Cao, Hangzhou (CN)

(21) Appl. No.: 19/560,407

(22) Filed: Mar. 9, 2026

(30) Foreign Application Priority Data
Mar. 18, 2025 (CN) 202510322786.7

(51) Int. Cl. G06F 13/40

(52) U.S. Cl. CPC G06F 13/4022

(57) ABSTRACT

An address expansion circuit for configuring an address of a chip, where: the address expansion circuit is coupled to at least one address pin of the chip, and is configured to encode the address of the chip differently according to different state information of the at least one address pin; the address expansion circuit is configured to determine whether the state information of the address pin is one of a first state group in a first detection interval, and to determine whether the state information of the address pin is one of a second state group in a second detection interval; and the first state group comprises floating, and the second state group comprises at least one of a high-level state, a low-level state, coupling with a communication input pin of the chip, and coupling with a communication output pin of the chip.

### RELATED APPLICATIONS

This application claims the benefit of Chinese Patent Application No. 202510322786.7, filed on March 18, 2025, which is incorporated herein by reference in its entirety.

### FIELD OF THE INVENTION

The present invention generally relates to the field of communications, and more particularly, address expansion circuits, communication interface chips, and backlight systems.

### BACKGROUND

Communication between a host and multiple slave devices is often required. To prevent conflicts during communication among multiple slaves, each slave may have a unique address. The chip of the slave typically has one or more address pins for address configuration, and the chip's address can be configured by connecting the address pins to a high level (e.g., a power supply or low level (e.g., ground).

### BRIEF DESCRIPTION OF THE DRAWINGS

FIG. 1 is a schematic circuit diagram of an example address expansion circuit.

FIG. 2 is a schematic circuit diagram of a first example address expansion circuit, in accordance with embodiments of the present invention.

FIG. 3 is a schematic circuit diagram of a second example address expansion circuit, in accordance with embodiments of the present invention.

FIG. 4 is a waveform diagram of an example operation of a control circuit, in accordance with embodiments of the present invention.

FIG. 5 is a schematic circuit diagram of a third example address expansion circuit, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

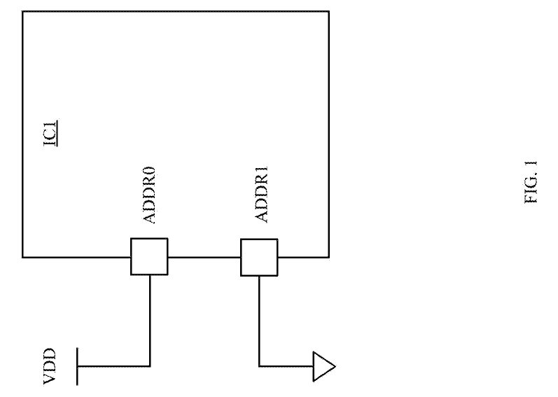

Referring now to FIG. 1, shown is a schematic circuit diagram of an address expansion circuit. In this particular example, chip IC1 can include two address pins ADDR0 and ADDR1, and each address pin may have two states, namely, receiving a high-level signal (e.g., coupling to power supply VDD) and a low-level signal (e.g., coupling to ground potential). Thus, two address pins of the chip can configure four addresses. When address pins ADDR0 and ADDR1 are in different level states, the chip may be configured with different addresses.

In order to realize multiple addresses configuration for multiple same slaves, each slave may have multiple address pins, which can form a unique combination to generate addresses different from other slaves. The more slaves in the system, the more address pins of the chip are required, so the size of the chip and the cost of the system can accordingly increase. Therefore, an address expansion circuit may be provided that can expand the addresses of the slave without increasing the number of address pins, in order to overcome such drawbacks.

Particular embodiments provide an address expansion circuit for configuring an address of a chip. The address expansion circuit can be coupled to an address pin of the chip, and may determine the state information of the address pin to encode the address of the chip differently according to different state information of the address pin. In a first detection interval, the address expansion circuit can determine whether the state information of the address pin is one of a first state group, where the first state group can include floating. In a second detection interval, the address expansion circuit can determine whether the state information of the address pin is one of a second state group, where the second state group can include at least one of a high-level state, a low-level state, coupling with a communication input pin of the chip, and coupling with a communication output pin of the chip. For example, the first detection interval and the second detection interval may have no overlapping region. In one embodiment, the first detection interval is before the second detection interval. In another embodiment, the second detection interval is before the first detection interval.

In one embodiment, the state information of the address pin can include floating, and also at least two of being in the high-level state, being in the low-level state, coupling with the communication input pin of the chip, and coupling with the communication output pin of the chip. Thus, one address pin can receive three or more different signals, enabling the configuration of three or more addresses for the chip. When address configuration is performed in this manner, if a chip has N address pins, a maximum of 5^N addresses can be configured, thereby expanding the address of the chip without increasing the number of address pins. However, any number of state information items can be supported in certain embodiments. For example, the state information of the address pin can at least include floating and at least one of the high-level state, the low-level state, coupling with the communication input pin, and coupling with the communication output pin.

In one embodiment, the address expansion circuit can correspond one-to-one with the address pins, with each address expansion circuit being coupled to a corresponding address pin to receive the input signal from that address pin. In one embodiment, during the second detection interval, it can be determined whether the address pin is in one of the high-level state, the low-level state, and coupling with the communication input pin. In another embodiment, during the second detection interval, it can be determined whether the address pin is in one of the high-level state, the low-level state, coupling with the communication output pin, and another known or unknown type of state information.

In yet another embodiment, during the second detection interval, it can be determined whether the address pin is in one of the high-level state, the low-level state, coupling with the communication input pin, coupling with the communication output pin, and another known or unknown type of state information. Any suitable solution that involves determining, during the second detection interval, whether the address pin is in at least one of the high-level state, the low-level state, coupling with the communication input pin, and coupling with the communication output pin, can be supported in certain embodiments. The following examples show state information including the high-level state, the low-level state, the floating, and coupling with the communication input pin for illustration. However, particular embodiments can support the state information of the address pin may being configured to include coupling with the communication output pin of the chip and/or other known or unknown types of state information.

The address expansion circuit of particular embodiments can include recognizing several different types of level information of the address pin in different detection intervals (e.g., in a time-sharing manner) to identify what type of signal is input to the address pin, thereby configuring the address of the chip accordingly. Among them, the high-level state and the low-level state are fixed level states. In the floating, the level of the address pin can change according to the change of the internal level state of the chip. Also, the state of being coupled to the communication input pin, the communication output pin, or other substitute pins can be equivalent to the address pin receiving a pulse-width modulation (PWM) signal, which presents both high and low-level states within a certain period. After determining the state information of the address pin, the address expansion circuit can perform different address encodings according to the different state information. Several specific examples of the address expansion circuit are provided below. However, any address expansion circuit that recognizes several different level information of the address pin in different detection intervals to determine the state information of the address pin and perform address encoding can be supported in certain embodiments.

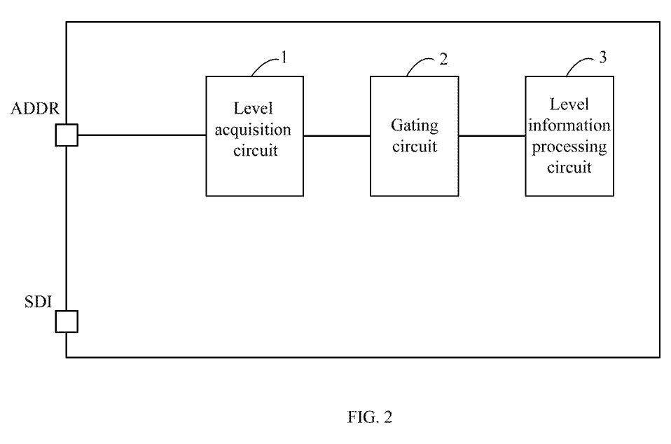

Referring now to FIG. 2, shown is a schematic circuit diagram of a first example address expansion circuit, in accordance with embodiments of the present invention. In this particular example, the address expansion circuit can include level acquisition circuit 1. Level acquisition circuit 1 can be coupled to address pin ADDR to acquire level information of the address pin in a time-sharing manner. The address expansion circuit can, during the first detection interval and the second detection interval, determine the state information of the address pin according to the level information of the address pin, in order to perform address encoding. Level acquisition circuit 1 can include a level providing circuit. The level providing circuit can provide a high voltage and a low voltage for the address pin in a time-sharing manner during the first detection interval, e.g., to provide a high voltage and a low voltage for the address pin respectively in a first sub-interval and a second sub-interval of the first detection interval. Further, in one embodiment, during the first detection interval, when the level providing circuit provides a high level for the address pin and the level of the address pin remains consistently high, and when the level providing circuit provides a low level for the address pin and the level of the address pin remains consistently low, it can be determined that the state information of the address pin is floating.

During the second detection interval, when the level of the address pin remains consistently high, it can be determined that the state information of the address pin is the high-level state. When the level of the address pin remains consistently low, it can be determined that the state information of the address pin is the low-level state. When the level of the address pin can include both high and low levels, it can be determined that the state information of the address pin is being coupled to the communication input pin, the communication output pin, or another pin. In one example implementation, the level providing circuit can include first and second switches connected in series between a power supply voltage and a ground potential, where a common node of the first and second switches is coupled to the address pin. During the first detection interval, the first and second switches can be turned on in a time-sharing manner, and the state information of the address pin can be determined according to the voltage at the common node of the first and second switches.

During the second detection interval, the state information of the address pin can be determined according to the level information of the address pin, in order to perform address encoding. For example, during the first sub-interval of the first detection interval, the first switch can be turned on, and during the second sub-interval of the first detection interval, the second switch can be turned on. It should be understood that the term "turned on in a time-sharing manner" means they are not turned on simultaneously. For example, when the first switch is on, the second switch can be off, and when the second switch is on, the first switch can be off. In another example, the level providing circuit may have other structures, and any level providing circuit capable of providing a high voltage and a low voltage for the address pin in a time-sharing manner during the first detection interval can be supported in certain embodiments.

In one embodiment, during the first detection interval, the communication input pin or the communication output pin of the chip may not output a PWM signal, meaning there are no pulse edge transitions on the communication input pin or communication output pin. Optionally, during the first detection interval, the communication input pin or communication output pin can output a fixed-level signal, e.g., a high-level signal or a low-level signal. In one embodiment, during the second detection interval, the communication input pin or the communication output pin of the chip can output a PWM signal, e.g., a level transition signal. In one embodiment, the second detection interval can include at least one pulse edge transition of the PWM signal.

In one embodiment, the communication input pin of the chip may receive an address configuration command, and after a first delay time, it can enter the first detection interval. During the first detection interval, it can be determined whether the address pin is floating. Subsequently, the communication input pin of the chip may receive a detection instruction command and it enters the second detection interval. During the second detection interval, the communication input pin may receive a PWM signal, and it can be determined whether the address pin is in at least one of the high-level state, the low-level state, coupling with the communication input pin, and coupling with the communication output pin. In this embodiment, the first detection interval can be before the second detection interval.

In another embodiment, through corresponding configurations, the first detection interval can be arranged after the second detection interval. For example, after the communication input pin of the chip may receive the address configuration command, if the communication input pin receives the detection instruction command, it can enter the second detection interval. During the second detection interval, the communication input pin may receive a PWM signal, and it can be determined whether the address pin is in at least one of the high-level state, the low-level state, coupling with the communication input pin, and coupling with the communication output pin. Starting from when the communication input pin stops receiving the PWM signal, after the first delay time, it can enter the first detection interval.

During the first detection interval, it can be determined whether the address pin is floating. Any solution that involves detecting the state information of the address pin in a time-sharing manner may be supported in certain embodiments. In some approaches, when using a single detection interval to detect all state information of an address pin, if the address pin is extended using a long FPC line, the parasitic capacitance can be relatively large and susceptible to interference from high-frequency signals. This can make the floating state difficult to detect, leading to detection errors, such as misjudging the floating state as the high-level state, low-level state, coupling with the communication input pin, or coupling with the communication output pin. The address expansion circuit of particular embodiments can address the drawbacks of the aforementioned technical solution by detecting the state information of the address pin in a time-sharing manner.

Further, during the first detection interval, the first and second switches can be turned on in a time-sharing manner. When the first switch is on, the voltage at the common node of the first and second switches may remain at a consistently high level, and when the second switch is on, the voltage at the common node may remain at a consistently low level, and it can be determined that the address pin is floating. During the second detection interval, when the voltage of the address pin remains at a consistently high level, it can be determined that the address pin is consistently in the high-level state, e.g., the address pin is coupled to a power pin of the chip or to a power supply terminal of another device or chip external to the chip. During the second detection interval, when the voltage of the address pin remains at a consistently low level, it can be determined that the address pin is consistently in the low-level state, e.g., the address pin is coupled to a ground potential pin of the chip or to a ground potential terminal of another device or chip external to the chip or to a common ground potential terminal. During the second detection interval, the communication input pin can output a PWM signal, which has both high and low levels. Therefore, when the voltage of the address pin contains both high and low levels, it can be determined that the address pin is coupled to the communication input pin.

In other embodiments, during the second detection interval, the communication output pin may output a PWM signal, which has both high and low levels. Therefore, when the voltage of the address pin contains both high and low levels, it can be determined that the address pin is coupled to the communication output pin. Moreover, the communication input pin or the communication output pin can be replaced by other pins, such as the address pin being coupled to a pin to receive a signal that contains both high and low levels. During the second detection interval, the communication input pin, communication output pin, or other substitute pins output PWM signals. At other times, these pins may have other functions.

In one embodiment, the address expansion circuit can also include gating circuit 2 and level information processing circuit 3. Gating circuit 2 can transmit, during the first and second detection intervals, a first signal representing the level information of the address pin and an inverted signal of first signal to level information processing circuit 3. Level information processing circuit 3 can perform latch processing on the first signal representing the level information of the address pin and the inverted signal thereof during the first and second detection intervals to obtain a plurality of state indication signals, where the plurality of state indication signals are used to characterize the state information of the address pin.

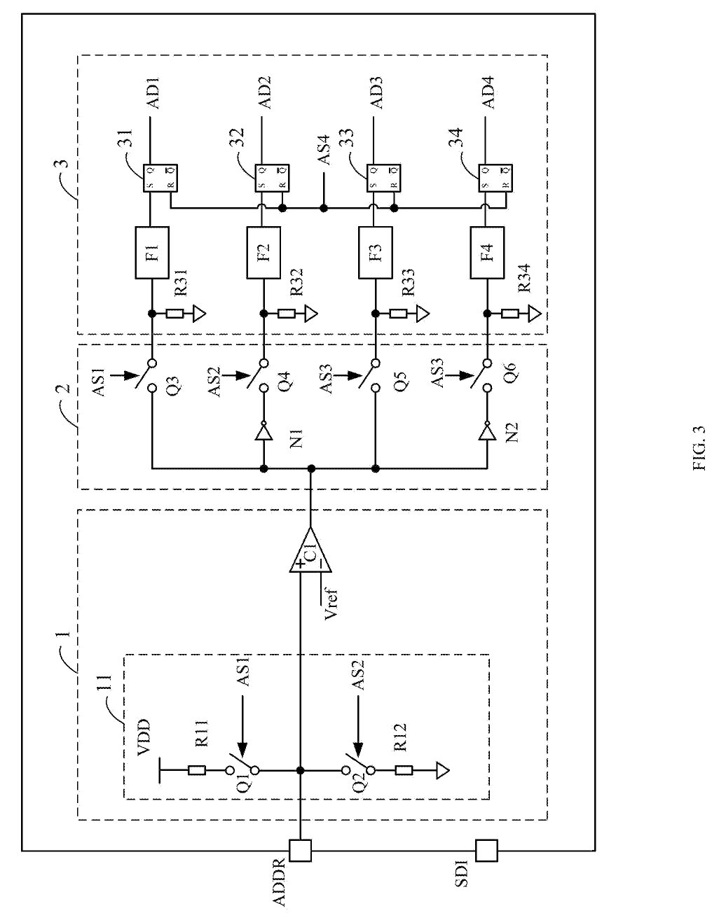

Referring now to FIG. 3, shown is a schematic circuit diagram of a second example address expansion circuit, in accordance with embodiments of the present invention. In this particular example, the address expansion circuit can include level acquisition circuit 1, gating circuit 2, and level information processing circuit 3. Level acquisition circuit 1 can be coupled to address pin ADDR to acquire level information of address pin ADDR in a time-sharing manner. The address expansion circuit can, during the first and second detection intervals, determine the state information of address pin ADDR according to the level information of address pin ADDR, in order to perform address encoding. Further, level acquisition circuit 1 can include level providing circuit 11, configured to provide a high voltage and a low voltage for address pin ADDR in a time-sharing manner during the first detection interval.

In one embodiment, level providing circuit 11 can include switches Q1 and Q2. Switches Q1 and Q2 can connect in series between power supply voltage VDD and a ground potential. A common node of switches Q1 and Q2 can be coupled to address pin ADDR. During the first detection interval, switches Q1 and Q2 can be turned on in a time-sharing manner, and the state information of address pin ADDR is determined according to the voltage at the common node of switches Q1 and Q2. During the second detection interval, the state information of address pin ADDR can be determined according to the level information of address pin ADDR, in order to perform address encoding.

Gating circuit 2 can transmit, during the first and second detection intervals, a first signal representing the level information of the address pin and an inverted signal of the first signal to level information processing circuit 3. Level information processing circuit 3 can perform latch processing on the first signal representing the level information of the address pin and the inverted signal of the first signal during the first and second detection intervals to obtain a plurality of state indication signals, where the plurality of state indication signals are used to characterize the state information of the address pin. Further, gating circuit 2 can transmit, during the first detection interval, the first signal representing the level information of the address pin and inverted signal of the first signal to level information processing circuit 3 in a time-sharing manner.

In one embodiment, level acquisition circuit 1 can also include a comparison circuit. The comparison circuit can compare the voltage of the address pin against a first reference voltage to obtain a first signal representing the level information of the address pin. In one embodiment, the comparison circuit can include comparator C1. A non-inverting input terminal of comparator C1 can be coupled to address pin ADDR, an inverting input terminal of comparator C1 may receive reference voltage Vref, and an output terminal of comparator C1 may generate the first signal representing the level information of the address pin. In another embodiment, the input signals at the two input terminals of the comparator C1 can be swapped, and the logic of the subsequent circuits can be adjusted accordingly.

For example, during the first detection interval, switches Q1 and Q2 can be turned on in a time-sharing manner. When switch Q1 is on, gating circuit 2 may transmit a first signal representing the level information of the address pin to level information processing circuit 3 to generate state indication signal AD1. When switch Q2 is on, gating circuit 2 may transmit the inverted signal of the first signal representing the level information of the address pin to level information processing circuit 3 to generate state indication signal AD2. For example, during the second detection interval, gating circuit 2 may transmit the first signal representing the level information of the address pin to level information processing circuit 3 to generate state indication signal AD3. Simultaneously, gating circuit 2 may transmit the inverted signal of the first signal representing the level information of the address pin to level information processing circuit 3 to generate state indication signal AD4. In other embodiments, the gating circuit can be configured with other corresponding logic. Any gating circuit that transmits the first signal representing the level information of the address pin and the inverted signal of the first signal to level information processing circuit 3 during the first and second detection intervals to generate a plurality of state indication signals falls can be utilized in certain embodiments.

Further, in the first detection interval, during the period when switch Q1 is on, if the first signal is a high level, state indication signal AD1 can be maintained or latched at a high level during the detection interval. During the period when switch Q2 is on, if the first signal is a low level, state indication signal AD2 can be maintained or latched at a high level during the detection interval. During the second detection interval, if the first signal is a high level, state indication signal AD3 can be maintained or latched at a high level during the detection interval. If the first signal is a low level, state indication signal AD4 can be maintained or latched at a high level during the detection interval. The detection intervals mentioned here include the first and second detection intervals.

In one embodiment, level information processing circuit 3 can include RS latches 31, 32, 33, and 34. When switch Q1 is on, gating circuit 2 may transmit the first signal to set terminal S of RS latch 31, and output terminal Q of RS latch 31 can generate state indication signal AD1. When switch Q2 is on, gating circuit 2 may transmit the inverted signal of the first signal to set terminal S of RS latch 32, and output terminal Q of RS latch 32 can generate state indication signal AD2. During the second detection interval, gating circuit 2 may transmit the first signal to set terminal S of RS latch 33, and output terminal Q of RS latch 33 can generate state indication signal AD3. Further, gating circuit 2 may transmit the inverted signal of the first signal to set terminal S of RS latch 34, and output terminal Q of RS latch 34 can generate state indication signal AD4.

In one embodiment, the output terminal of comparator C1 may serve as the output terminal of level acquisition circuit 1. Gating circuit 2 can include switches Q3, Q4, Q5, and Q6. A first terminal of switch Q3 can be coupled to the output terminal of comparator C1, and a second terminal of switch Q3 can be coupled to set terminal S of RS latch 31. A first terminal of switch Q4 can be coupled to the output terminal of comparator C1 via inverter N1, and a second terminal of switch Q4 can be coupled to set terminal S of RS latch 32. A first terminal of switch Q5 can be coupled to the output terminal of comparator C1, and a second terminal of switch Q5 can be coupled to set terminal S of RS latch 33. A first terminal of switch Q6 can be coupled to the output terminal of comparator C1 via inverter N2, and a second terminal of switch Q6 can be coupled to set terminal S of RS latch 34. In another embodiment, the positions of switch Q4 and inverter N1 can be swapped, and the positions of switch Q6 and inverter N2 can be swapped. In one embodiment, during the first detection interval, the communication input pin or the communication output pin may output a high-level signal or a low-level signal. In one embodiment, during the second detection interval, the communication input pin or the communication output pin of the chip may output a PWM signal, e.g., a level transition signal.

Further, in this embodiment, when state indication signal AD1 is at a high level, state indication signal AD2 is at a low level, state indication signal AD3 is at a high level, and state indication signal AD4 is at a low level, it may indicate that address pin ADDR is consistently in the high-level state. When state indication signal AD1 is at a low level, state indication signal AD2 is at a high level, state indication signal AD3 is at a low level, and state indication signal AD4 is at a high level, it may indicate that address pin ADDR is consistently in the low-level state. When state indication signal AD1 is at a high level and state indication signal AD2 is at a high level, it may indicate that address pin ADDR is floating. In this case, state indication signals AD3 and AD4 can be at a high level or a low level, meaning that these state indication signals may not affect the determination of the floating state.

When state indication signal AD1 is at a high level, state indication signal AD2 is at a low level, and both state indication signals AD3 and AD4 are at a high level, or when state indication signal AD1 is at a low level, state indication signal AD2 is at a high level, and both state indication signals AD3 and AD4 are at a high level, it may indicate that address pin ADDR is coupled to communication input pin SDI. In other embodiments, communication output pin SDO or other substitute pins can be used instead of communication input pin SDI. In one embodiment, when state indication signals AD1, AD2, AD3, and AD4 are all at a first preset level (e.g., a low level), it may indicate that the chip has not started the addressing operation, e.g., the address is unassigned.

In one embodiment, level providing circuit 11 can also include resistors R11 and R12. Resistor R11 can be coupled between power supply voltage VDD and switch Q1, and resistor R12 can be coupled between switch Q2 and the ground potential. In other embodiments, resistor R11 can be coupled between switch Q1 and the common node of switches Q1 and Q2, and resistor R12 can be coupled between the common node of switches Q1 and Q2 and switch Q2. That is, the positions of resistor R11 and switch Q1 can be interchanged, and the positions of resistor R12 and switch Q2 can be interchanged.

In one embodiment, level information processing circuit 3 can also include filter circuits F1, F2, F3, and F4 to filter the signals output by gating circuit 2, respectively. For example, filter circuit F1 can be coupled between switch Q3 and RS latch 31, filter circuit F2 can be coupled between switch Q4 and RS latch 32, filter circuit F3 can be coupled between switch Q5 and RS latch 33, and filter circuit F4 is coupled between switch Q6 and RS latch 34. In one embodiment, level information processing circuit 3 can also include resistors R31, R32, R33, and R34. Resistor R31 can be coupled between the common node of switch Q3 and filter circuit F1 and the ground potential. Resistor R32 can be coupled between the common node of switch Q4 and filter circuit F2 and the ground potential. Resistor R33 can be coupled between the common node of switch Q5 and filter circuit F3 and the ground potential. Also, resistor R34 can be coupled between the common node of switch Q6 and filter circuit F4 and the ground potential.

In another embodiment, resistor R31 can be coupled between the common node of switch Q3 and filter circuit F1 and power supply voltage VDD, and resistor R32 can be coupled between the common node of switch Q4 and filter circuit F2 and power supply voltage VDD. Resistor R33 can be coupled between the common node of switch Q5 and filter circuit F3 and power supply voltage VDD. Also, resistor R34 can be coupled between the common node of switch Q6 and filter circuit F4 and power supply voltage VDD. In these cases, the corresponding logic of the different level of a plurality of state indication signals in the subsequent stages and the different state information of the address pin can be adjusted accordingly.

The address expansion circuit also can include an encoding circuit, which can encode the address of the chip according to the plurality of state indication signals. For example, when state indication signal AD1 is at a high level, state indication signal AD2 is at a low level, state indication signal AD3 is at a high level, and state indication signal AD4 is at a low level, the encoding circuit may generate a first address (e.g., 00). When state indication signal AD1 is at a low level, state indication signal AD2 is at a high level, state indication signal AD3 is at a low level, and state indication signal AD4 is at a high level, the encoding circuit may generate a second address (e.g., 01). When state indication signal AD1 is at a high level, state indication signal AD2 is at a high level, and state indication signal AD3 and state indication signal AD4 are at either a high level or a low level, the encoding circuit may generate a third address (e.g., 10). When state indication signal AD1 is at a high level, state indication signal AD2 is at a low level, state indication signal AD3 is at a high level, and state indication signal AD4 is at a high level, or when state indication signal AD1 is at a low level, state indication signal AD2 is at a high level, state indication signal AD3 is at a high level, and state indication signal AD4 is at a high level, the encoding circuit may generate a fourth address (e.g., 11).

The address expansion circuit also can include a control circuit, which can generate control signals AS1, AS2, and AS3. Control signal AS1 can control switches Q1 and Q3. Control signal AS2 can control switches Q2 and Q4. Control signal AS3 can control switches Q5 and Q6. The active intervals of control signals AS1 and AS2 may not overlap. Further, the control circuit can also generate control signal AS4. Reset terminals R of RS latches 31, 32, 33, and 34 may all receive control signal AS4. The start time of the detection intervals can be at or after the moment when control signal AS4 changes from active to inactive.

In the first detection interval, communication input pin SDI may output a high-level signal or low-level signal. In the first sub-interval of the first detection interval, control signal AS1 can be active, while control signals AS2 and AS3 can be inactive. In the second sub-interval of the first detection interval, control signal AS2 can be active, while control signals AS1 and AS3 may be inactive. The active intervals of control signals AS1 and AS2 may not overlap. In the second detection interval, control signal AS3 can be active, while control signals AS1 and AS2 may be inactive. In the second detection interval, communication input pin SDI can output a PWM signal. In the second detection interval, that is, active interval of control signal AS3 can include at least one pulse edge transition of the PWM signal. When the chip contains N address pins ADDR1-ADDRN, each address pin can correspond to the aforementioned address expansion circuit. In one embodiment, one address pin can encode 4 addresses through the aforementioned address expansion circuit, so N address pins, through N address expansion circuits, can configure up to 4^N addresses.

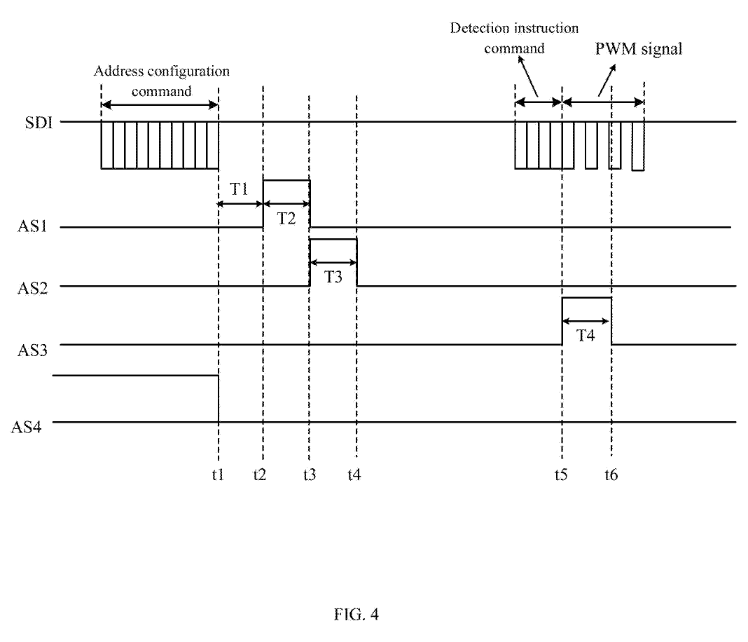

Referring now to FIG. 4, shown is a waveform diagram of an example operation of a control circuit, in accordance with embodiments of the present invention. In this particular example, after the chip starts, at time t1, communication input pin SDI may receive an address configuration command. Starting from time t1, delay time T1 can be delayed, that is, at time t2, it may enter the first detection interval to avoid interference and improve detection accuracy. In this example, in the first detection interval, communication input pin SDI may output a high-level signal. In first sub-interval t2-t3 of the first detection interval, control signal AS1 can be active, and the active time of control signal AS1 is T2. In second sub-interval t3-t4 of the first detection interval, control signal AS2 can be active, and the active time of control signal AS2 is T3. In this example, in the first detection interval, control signals AS1 and AS2 can be active once each. That is, the first detection interval can include only one first sub-interval and one second sub-interval, which can be sufficient to determine whether the state information of the address pin is floating. In other examples, to avoid misjudgment, in the first detection interval, control signals AS1 and AS2 can be active multiple times.

That is, the first detection interval can include multiple first sub-intervals and multiple second sub-intervals, and through multiple recognitions, it may determine whether the state information of the address pin is floating. At time t5, the communication input pin of the chip may receive a detection instruction command, and it can enter the second detection interval. In second detection interval t5-t6, the communication input pin may receive a PWM signal, and control signal AS3 can be active to determine whether the address pin is in at least one of the high-level state, low-level state, coupling with the communication input pin, and coupling with the communication output pin. The active time of control signal AS3 is T4, and the second detection interval can include at least one pulse edge transition of the PWM signal. The second detection interval can include one period of the PWM signal, or can include multiple periods of the PWM signal. Thus, using the aforementioned address expansion circuit, within the detection intervals (e.g., including the first and second detection intervals), the level states of state indication signals AD1, AD2, AD3, and AD4 may be obtained. Different state information of the address pin ADDR can correspond to different level states of state indication signals AD1, AD2, AD3, and AD4. Therefore, at the end of or after the detection intervals, the level states of the multiple state indication signals can be detected to encode the address of the chip differently. In this example, the detection interval is interval t2-t6, and the level states of state indication signals AD1, AD2, AD3, and AD4 can be detected at or after time t6.

In one embodiment, there may be no interval between the detection instruction command and the PWM signal. That is, after the detection instruction command is sent, the PWM signal can be sent immediately, as shown in FIG. 4. In one implementation, the detection instruction command and the PWM signal may be different parts of the same signal. In another implementation, the detection instruction command and the PWM signal can be different signals, and there may be no interval between the two different signals. In another embodiment, there can be an interval between the detection instruction command and the PWM signal. That is, after the detection instruction command is sent, there may be an interval before the PWM signal is sent.

In one example, at time t1, upon receiving the address configuration command, control signal AS4 can transition from a high level to a low level. In another example, at time t2, control signal AS4 can transition from a high level to a low level, as long as control signal AS4 transitions from a high level to a low level before time t2. At this time, reset terminals R of RS latches 31, 32, 33, and 34 may all receive a low level. Control signal AS4 can transition from a low level to a high level before the next first detection interval arrives.

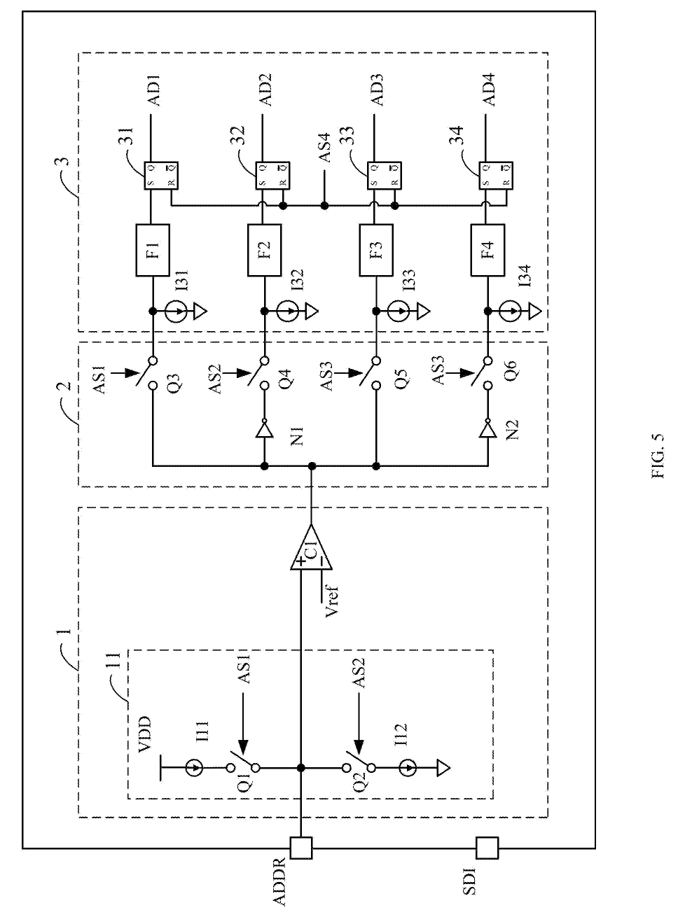

Referring now to FIG. 5, shown is a schematic circuit diagram of a third example address expansion circuit, in accordance with embodiments of the present invention. In this particular example, resistors R11, R12, R31, R32, R33, and R34 are replaced by current sources. In other embodiments, some of resistors R11, R12, R31, R32, R33, and R34 are replaced by current sources, and the remaining parts remain as resistors.

Particular embodiments may also provide a communication interface chip, including at least one address expansion circuit, whereby each address expansion circuit is coupled to a corresponding address pin. Further, the communication interface chip can include a communication input pin, a communication output pin, and at least one address pin. When the communication interface chip requires address configuration, the address pin can be in at least two of the high-level state, the low-level state, being coupled to the communication input pin, floating, and being coupled to the communication output pin. In one embodiment, the communication interface chip can also include a power pin and a ground potential pin. The address pin can be in at least two of being coupled to the communication input pin, being coupled to the power pin, being coupled to the ground potential pin, floating, and being coupled to the communication output pin.

In another embodiment, the address pin can be in at least two of being coupled to the communication input pin, being coupled to a power supply terminal of other devices or chips external to the communication interface chip, being coupled to a ground potential terminal of other devices or chips external to the communication interface chip or a common ground potential terminal, floating, and being coupled to the communication output pin of the chip. The present invention also provides a backlight system, including a plurality of the aforementioned communication interface chips. The plurality of communication interface chips can connect in series and/or in parallel.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. An address expansion circuit for configuring an address of a chip, wherein:
a) the address expansion circuit is coupled to at least one address pin of the chip, and is configured to encode the address of the chip differently according to different state information of the at least one address pin;b) the address expansion circuit is configured to determine whether the state information of the address pin is one of a first state group in a first detection interval, and to determine whether the state information of the address pin is one of a second state group in a second detection interval; andc) the first state group comprises floating, and the second state group comprises at least one of a high-level state, a low-level state, coupling with a communication input pin of the chip, and coupling with a communication output pin of the chip.

2. The address expansion circuit of claim 1, wherein the first detection interval and the second detection interval have no overlapping region.

3. The address expansion circuit of claim 1, wherein the address expansion circuit comprises:
a) a level acquisition circuit coupled to the address pin, configured to acquire level information of the address pin in a time-sharing manner; andb) wherein the address expansion circuit is configured to determine the state information of the address pin according to the level information of the address pin in the first detection interval and the second detection interval, in order to encode the address of the chip.

4. The address expansion circuit of claim 3, wherein the level acquisition circuit comprises a level providing circuit configured to provide a high voltage and a low voltage for the address pin respectively in a first sub-interval and a second sub-interval of the first detection interval, in order to determine whether the address pin is floating according to the level information of the address pin in the first detection interval.

5. The address expansion circuit of claim 4, wherein the level providing circuit comprises:
a) a first switch and a second switch, coupled in series between a power supply voltage and a ground potential;b) wherein a common node of the first and second switches is coupled to the address pin, the first switch and the second switch are respectively turned on in the first sub-interval and the second sub-interval of the first detection interval, in order to determine whether the address pin is floating according to the level information of the address pin in the first detection interval.

6. The address expansion circuit of claim 4, wherein when the address pin is consistently at a high level in the first sub-interval of the first detection interval, and consistently at a low level in the second sub-interval of the first detection interval, it is determined that the address pin is floating.

7. The address expansion circuit of claim 3, wherein when the address pin is consistently at a high level in the second detection interval, it is determined that the address pin is in the high-level state.

8. The address expansion circuit of claim 3, wherein when the address pin is consistently at a low level in the second detection interval, it is determined that the address pin is in the low-level state.

9. The address expansion circuit of claim 3, wherein in the second detection interval, the communication input pin or the communication output pin outputs a PWM signal, and when the level of the address pin has both a high level and a low level, it is determined that the address pin is coupled to the communication input pin or the communication output pin.

10. The address expansion circuit of claim 3, wherein the address expansion circuit further comprises:
a) a gating circuit configured to transmit a first signal representing the level information of the address pin generated by the level acquisition circuit and an inverted signal of a first signal to a level information processing circuit in the first detection interval and the second detection interval;b) wherein the level information processing circuit is configured to latch the first signal representing the level information of the address pin and the inverted signal of a first signal in the first detection interval and the second detection interval to obtain a plurality of state indication signals, and wherein the plurality of state indication signals represents state information of the address pin.

11. The address expansion circuit of claim 10, wherein the level acquisition circuit further comprises a comparison circuit for comparing a voltage of the address pin against a first reference voltage to obtain the first signal representing the level information of the address pin.

12. The address expansion circuit of claim 10, wherein:
a) the gating circuit transmits the first signal representing the level information of the address pin to the level information processing circuit in the first sub-interval of the first detection interval to generate a first state indication signal; b) the gating circuit transmits the inverted signal of the first signal representing the level information of the address pin to the level information processing circuit in the second sub-interval of the first detection interval to generate a second state indication signal; andc) in the second detection interval, the gating circuit transmits the first signal representing the level information of the address pin to the level information processing circuit to generate a third state indication signal, and the gating circuit transmits the inverted signal of the first signal representing the level information of the address pin to the level information processing circuit to generate a fourth state indication signal.

13. The address expansion circuit of claim 10, wherein:
a) the level information processing circuit comprises a first RS latch, a second RS latch, a third RS latch, and a fourth RS latch;b) in the first sub-interval of the first detection interval, the gating circuit transmits the first signal to a set terminal of the first RS latch, and an output terminal of the first RS latch generates a first state indication signal;c) in the second sub-interval of the first detection interval, the gating circuit transmits the inverted signal of the first signal to a set terminal of the second RS latch, and an output terminal of the second RS latch generates a second state indication signal; andd) in the second detection interval, the gating circuit transmits the first signal to a set terminal of the third RS latch, an output terminal of the third RS latch generates a third state indication signal, and the gating circuit transmits the inverted signal of the first signal to a set terminal of the fourth RS latch, and an output terminal of the fourth RS latch generates the fourth state indication signal.

14. The address expansion circuit of claim 1, wherein:
a) in the first detection interval, the communication input pin or the communication output pin outputs a high-level signal or a low-level signal;b) in the second detection interval, the communication input pin or the communication output pin outputs a PWM signal; andc) the second detection interval comprises at least one pulse edge transition of the PWM signal.

15. The address expansion circuit of claim 12, wherein:
a) during the first sub-interval of the first detection interval, when the first signal has a high level, the first state indication signal is maintained at a high level during a detection interval; b) during the second sub-interval of the first detection interval, when the first signal has a low level, the second state indication signal is maintained at a high level during the detection interval; andc) in the second detection interval, when the first signal has a high level, the third state indication signal is maintained at a high level during the detection interval, and when the first signal has a low level, the fourth state indication signal is maintained at a high level during the detection interval.

16. The address expansion circuit of claim 15, wherein:
a) when the first state indication signal is at a high level, the second state indication signal is at a low level, the third state indication signal is at a high level, and the fourth state indication signal is at a low level, it indicates that the address pin is in the high-level state;b) when the first state indication signal is at a low level, the second state indication signal is at a high level, the third state indication signal is at a low level, and the fourth state indication signal is at a high level, it indicates that the address pin is in the low-level state;c) when the first state indication signal is at a high level, the second state indication signal is at a high level, and the third state indication signal and the fourth state indication signal are at a high level or a low level, it indicates that the address pin is floating; andd) when the first state indication signal is at one of a high level and a low level, the second state indication signal is at the other one of a high level and a low level, the third state indication signal is at a high level, and the fourth state indication signal is at a high level, it indicates that the address pin is coupled to the communication input pin or the communication output pin.

17. The address expansion circuit of claim 10, wherein:
a) the address expansion circuit further comprises a control circuit for generating a first control signal, a second control signal, and a third control signal; andb) an active interval of the first control signal is configured as the first sub-interval of the first detection interval, an active interval of the second control signal is configured as the second sub-interval of the first detection interval, and an active interval of the third control signal is configured as the second detection interval.

18. The address expansion circuit of claim 13, wherein the gating circuit comprises:
a) a third switch, having a first terminal coupled to an output terminal of the level acquisition circuit, and a second terminal coupled to the set terminal of the first RS latch;b) a fourth switch, having a first terminal coupled to the output terminal of the level acquisition circuit via a first inverter, and a second terminal coupled to the set terminal of the second RS latch;c) a fifth switch, having a first terminal coupled to the output terminal of the level acquisition circuit, and a second terminal coupled to the set terminal of the third RS latch;d) a sixth switch, having a first terminal coupled to the output terminal of the level acquisition circuit via a second inverter, and a second terminal coupled to the set terminal of the fourth RS latch; ande) wherein switching states of the third switch is the same as switching states of the first switch, switching states of the fourth switch is the same as switching states of the second switch, and switching states of the fifth switch is the same as switching states of the sixth switch.

19. A communication interface chip, comprising at least one address expansion circuit of claim 1, wherein each address expansion circuit is coupled to a corresponding address pin.

20. A backlight system, comprising at least one communication interface chip of claim 19.
